(19) United States
(12) Patent Application Publication
(10) Pub. No.: US 2017/0203343 A1
(43) Pub. Date: Jul. 20, 2017

(54) Method And Apparatus for Dissolving Animal Waste

(71) Applicant: Satish Poddar, Duluth, GA (US)

(72) Inventor: Satish Poddar, Duluth, GA (US)

(21) Appl. No.: 14/996,853

(22) Filed: Jan. 15, 2016

(51) Int. Cl. B09B 3/00; B05B 12/00; A01K 1/01; A62D 3/38; E01H 1/00; B05B 7/24; A62D 3/36

(52) U.S. Cl. CPC B09B 3/00; B05B 7/2494; B05B 12/002; A62D 3/36; A62D 3/38; E01H 1/008; A01K 1/01; A62D 2101/20

(57) ABSTRACT

An apparatus for at least partially dissolving animal waste may include a housing upon which a first and second chamber may be attached. The first chamber may contain a first substance and the second chamber may contain a second substance. Upon application of the first substance and the second substance to the animal waste, a reaction may occur to dissolve at least a portion of the animal waste. A first trigger and a second trigger may each be attached to the housing. The first trigger may be configured so that upon operation on the first trigger, the first substance is expelled from the apparatus. The second trigger may be configured so that upon operation of the second trigger, the second substance is expelled from the apparatus.

### TECHNICAL FIELD

The technical field relates generally to animal waste removal and more particularly to a method and apparatus for dissolving animal waste.

### BACKGROUND

Undoubtedly one of the least enjoyable aspects of pet ownership includes the collection and disposal of the feces left by the pet. When a dog owner, for example, takes a dog for a walk in a park or other public area, he or she may have to manually collect the dog's feces in a plastic bag and then carry the filled bag with him or her until reaching home or a waste receptacle. Even a pet owner with a yard in which a dog or other pet may relieve itself may have to periodically collect, such as with a scoop device, the pet's feces from around the yard in order to avoid the unsightly and malodorous consequences of failing to do so. Collecting an animal's waste and, in some circumstances, carrying around a bag of an animal's waste may be an unpleasant experience to many individuals.

### SUMMARY

A method and apparatus for at least partially dissolving animal waste is disclosed. In an aspect, the apparatus may include a housing, a first chamber for containing a first substance may be connected to the housing, and a second chamber for containing a second substance may also be connected to the housing. The apparatus may further include a first trigger and a second trigger, each connected to the housing. The first trigger may be configured, upon operation of the first trigger, to cause the first substance to be expelled from the apparatus. The second trigger may be configured, upon operation of the second trigger, to cause the second substance to be expelled from the apparatus.

In an aspect, the apparatus may include a housing having an outlet. A first chamber for containing a first substance may be connected to the housing. A second chamber for containing a second substance may also be connected to the housing. The apparatus may further include a trigger connected to the housing. The trigger may be configured, upon operation of the trigger, to cause at least one of the first substance or the second substance to be expelled from the apparatus via the outlet.

In an aspect, a method for at least partially dissolving animal waste may include operating a trigger mechanism of an apparatus to cause a first substance to be expelled from the apparatus onto the animal waste. The first substance may be contained in a first chamber of the apparatus. The method may further include operating the trigger mechanism of the apparatus to cause a second substance to be expelled from the apparatus onto the animal waste. The second substance may be contained in a second chamber of the apparatus.

### BRIEF DESCRIPTION OF THE DRAWINGS

The following detailed description is better understood when read in conjunction with the appended drawings. For the purposes of illustration, exemplary examples are shown in the drawings; however, the subject matter is not limited to the specific elements and instrumentalities disclosed. In the drawings:

FIG. 1 illustrates a perspective view of an exemplary apparatus for dissolving animal waste;

FIG. 2 illustrates a schematic diagram of an exemplary configuration of an exemplary apparatus;

FIG. 3 illustrates a schematic diagram of an exemplary configuration of an exemplary apparatus;

FIG. 4 illustrates a schematic diagram of an exemplary configuration of an exemplary apparatus;

FIG. 5 illustrates a schematic diagram of an exemplary configuration of an exemplary apparatus; and

FIG. 6 illustrates a schematic diagram of an exemplary configuration of an exemplary apparatus.

### DETAILED DESCRIPTION OF ILLUSTRATIVE EMBODIMENTS

Described herein are a method and apparatus for at least partially dissolving animal waste. The apparatus may contain, for example, a first chamber and a second chamber. The first chamber may be filled with a first liquid and the second chamber may be filled with a different second liquid. The first and second liquids may be of such nature as, when combined, an exothermic reaction may occur that facilitates dissolving an article of animal waste upon which the liquids are sprayed. By storing the first liquid and the second liquid in separate chambers, the chemical reaction resulting from the combination of the two liquids may be delayed until the first and second liquid are both sprayed upon an article of animal waste. The apparatus may include means for separately spraying the first and second liquids, such as two triggers or a single trigger combined with a switch to control which liquid is sprayed. As an example, the apparatus may be used to dissolve animal waste, such as feces, by spraying one of the liquids on to the animal waste and then spraying the other liquid onto the animal waste. When the two liquids are combined on the animal waste, an exothermic reaction may occur and dissolve at least a portion of the animal waste. The dissolved animal waste may then be harmlessly washed away or, if left to dry, blown or swept away.

In describing embodiments of the present disclosure illustrated in the figures, specific terminology is employed for the sake of clarity. The disclosure, however, is not intended to be limited to the specific terminology so selected, and it is to be understood that each specific element includes all technical equivalents that operate in a similar manner to accomplish a similar purpose.

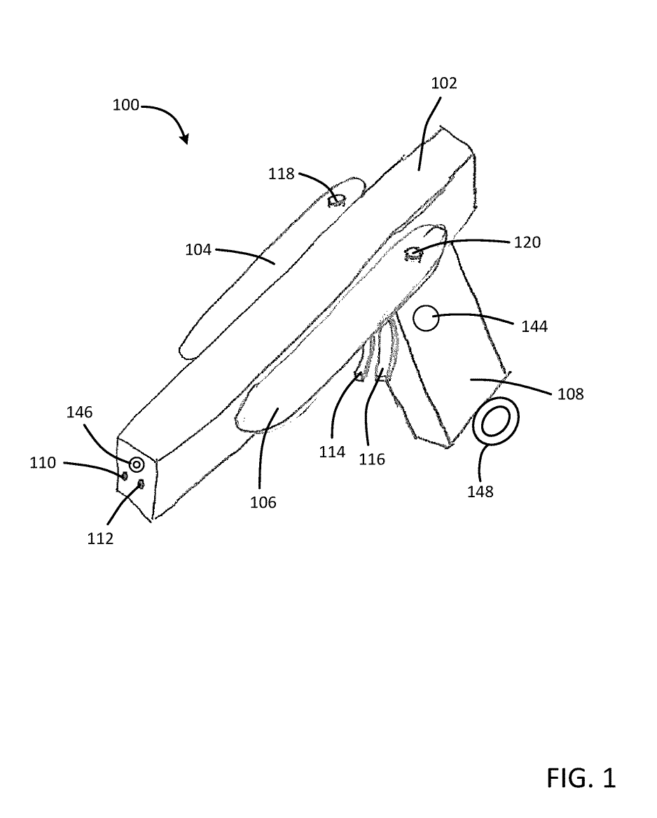

FIG. 1 illustrates a perspective view of an apparatus 100 for dissolving animal waste. The apparatus 100 may include a housing 102. Since the housing 102 may be exposed to water and other liquids, the housing 102 may be composed of a non-corrosive or corrosion-resistant material, such as plastic, metal (e.g., stainless steel), or a combination thereof. A handle 108 may be connected to the housing 102 or may be integrated with the housing 102 (and thus comprise part of the housing 102). The handle 108 may be used by a user to grasp the apparatus 100. Accordingly, the handle 108 may be configured to accommodate the user's hand. Similar to the housing 102, the handle 108 may be composed of a non-corrosive or corrosion-resistant material, such as plastic, metal, or a combination thereof. In one exemplary embodiment, the housing 102 and the handle 108 may be arranged in a pistol-like configuration.

The apparatus 100 may include a plurality of chambers, such as a first chamber 104 and a second chamber 106, each configured to securely contain a liquid (e.g., each chamber is water-tight). The first chamber 104 may contain a first liquid and the second chamber 106 may contain a second liquid. The first liquid and the second liquid may be different from one another. Each of the first chamber 104 and the second chamber 106 may be connected to the housing 102. As shown in FIG. 1, the first chamber 104 and the second chamber 106 may be attached to opposite sides of the housing 102 such that the length of the housing 102 is parallel to the length of each of the first chamber 104 and the second chamber 106. In some embodiments, one or more of the first chamber 104 and the second chamber 106 may be disposed within the housing 102 and/or the handle 108. For example, the first chamber 104 and the second chamber 106 may each be defined by the walls of the handle 108 and an internal divider within the handle 108. Each of the chambers, such as the first chamber 104 and the second chamber 106, may include an opening through which a liquid may be added to the chamber. For instance, the first chamber 104 may include a first opening 118 and the second chamber 106 may include a second opening 120. The first opening 118 and/or the second opening 120 may each be configured with a lid or cap (e.g., a screw-top cap) to prevent the liquid inside each of the first chamber 104 and/or the second chamber 106 from inadvertently spilling from the first chamber 104 and/or second chamber 106, respectively. In some aspects, one or more of the chambers 104, 106 may comprise a replaceable cartridge. As an example, the replaceable cartridge may be configured to screw into a cooperatively configured opening in the housing 102. The replaceable cartridge may be pressurized to expel the substance contained therein from the replaceable cartridge.

The apparatus 100 may include one or more triggers or buttons, such as a first trigger 114 and a second trigger 116, by which the user may effectuate the release of a liquid from one or more of the chambers, such as the first chamber 104 and/or the second chamber 106, from one or more outlets, such as a first outlet 110 and/or a second outlet 112. The first trigger 114 and the second trigger 116 may be movably attached to the housing 102 and/or the handle 108. The first trigger 114 and/or the second trigger 116 may be situated proximate to the junction of the housing 102 and the handle 108 so that the user may comfortably operate the first trigger 114 and/or the second trigger 116 while grasping the handle 108. The first outlet 110 and/or the second outlet 112 may be positioned at an end of the housing 102 distal from the portion of the housing 102 connected to the handle 108. The first outlet 110 may be fluidly connected to the first chamber 104 via, for example, a tube or piping within the housing 102. The second outlet 112 may be similarly connected to the second chamber 106. In some aspects, the first outlet 110 and the second outlet 112 may be combined into a common outlet (not shown), such that the respective liquids from the first chamber 104 and the second chamber 106 may be combined before exiting the apparatus 100 via the common outlet.

The apparatus 100 may further include a safety mechanism 144 whereby the apparatus 100 is prevented from being operated unless the safety mechanism 144 is activated prior to or during operation of the apparatus 100. As an example, the safety mechanism 144 may be mechanically connected to the various connections (e.g., tubes, piping, etc.) between one or more of the chambers 104, 106 and one or more of the outlets 110, 112 to prevent the substance from passing therein unless the safety mechanism 144 is activated. As another example, the safety mechanism 144 may be mechanically connected to one or more of the triggers 114, 116 to prevent the operation of the one or more triggers 114, 116 until the safety mechanism 144 is activated. The safety mechanism 144 may comprise a button or lever disposed on the exterior of the apparatus 100, such as on the handle 108 or the housing 102, by which the safety mechanism 144 may be activated. The safety mechanism 144 may be configured to be difficult to activate by a child, such as if the button or lever of the safety mechanism 144 is configured to require a large degree of pressure to manipulate or if the safety mechanism 144 includes two or more buttons or levels that must be simultaneously manipulated.

In an aspect, the safety mechanism 144 may include a mechanism by which the safety mechanism 144 may only be activated—and thus the apparatus 100 may only be operated—if the apparatus 100 is substantially pointed towards the ground. For example, the safety mechanism 144 may include a gyroscopic sensor that is configured to detect the three-dimensional orientation of the apparatus 100. As another example, a valve may be disposed in one or more of the connections between one or more of the chambers 104, 106 and one or more of the outlets 110, 112, wherein the valve may be configured with a gravity-activated stop. The gravity-activated stop, such as a ball, within the valve may be configured to block the flow of liquid or other form of substance through the valve while the apparatus 100 is not pointed substantially downward.

The apparatus 100 may be configured with a light 146. The light 146 may be embodied as a flashlight, such as to assist a user of the apparatus 100 in illuminating the animal waste and surrounding area in the dark. In another aspect, the light 146 may be embodied as a laser pointer, which may assist the user in aiming the apparatus 100 at the animal waste.

In one embodiment, the apparatus 100 may be incorporated with a leash handle. For example, the leash handle may include a retractable leash which may be used by a user to walk the user's dog or other animal. In another embodiment, the apparatus 100 may include an attachment point 148 for a leash, such as a loop, ring, or clip. The attachment point 148 may be connected to the handle 108 or the housing 102, for example.

While the disclosure herein primarily relates to the substances stored in chambers 104, 106 and expelled from outlets 110, 112 as being in liquid form, it is specifically contemplated that the disclosure is not so limited. For example, one or more of the substances may be in the form of a powder, aerosol, or gas suspension.

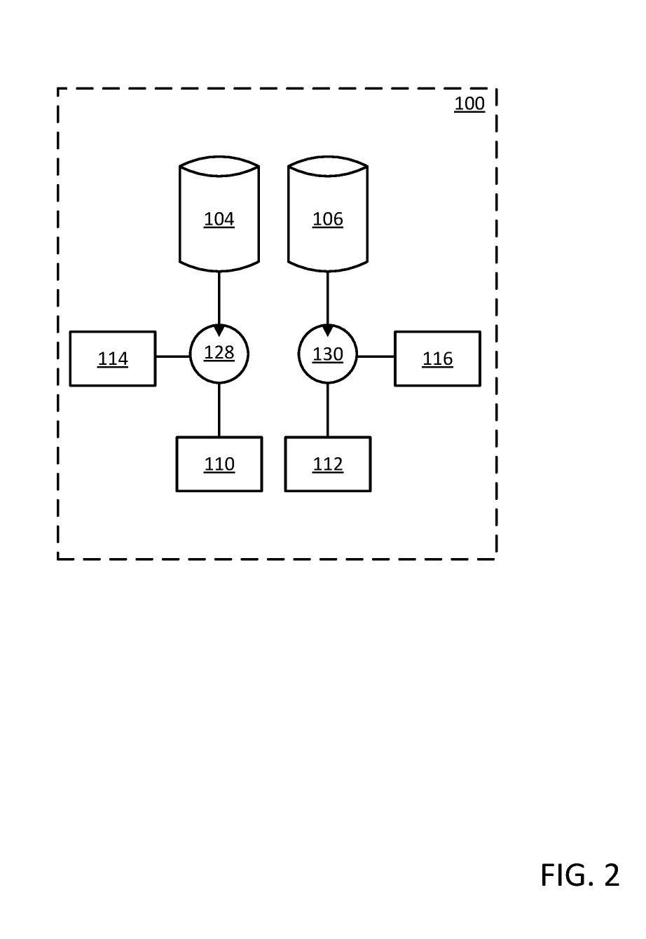

FIGS. 2-6 depict schematic illustrations of several exemplary configurations of the components of the apparatus 100 relating to a mechanism by which liquid from the first chamber 104 and/or the second chamber 106 may be expelled from the apparatus 100.

In FIG. 2, the apparatus 100 may include a first pump 128 disposed along a fluid connection between the first outlet 110 and the first chamber 104. The first pump 128 may be mechanically linked to the first trigger 114. When the first trigger 114 is operated by the user, this may cause the first pump 128 to force liquid from the first chamber 104 via the first outlet 110. Similarly, the apparatus 100 may include a second pump 130 disposed along a fluid connection between the second outlet 112 and the second chamber 106. The second pump 130 may be mechanically linked to the second trigger 116, such that an operation of the second trigger 116 may cause the second pump 130 to force liquid from the second chamber 106 via the second outlet 112.

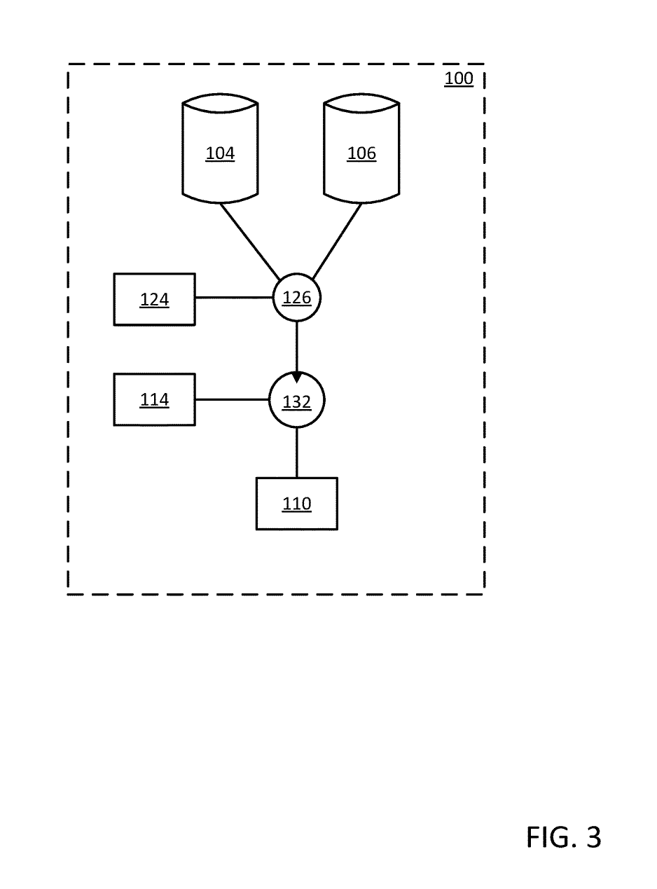

In FIG. 3, the apparatus 100 may include a single trigger, such as the first trigger 114, and a switch 124. The switch 124 may be situated, for example, on the housing 102 or the handle 108. The switch 124 may be manipulated to control whether liquid is expelled from the first chamber 104 and/or the second chamber 106. For example, the switch 124 may have a first position and second position. If the switch 124 is in the first position, the apparatus 100 may spray the liquid from the first chamber 104 when the user operates the first trigger 114. If the switch 124 is in the second position, the apparatus 100 may spray the liquid from the second chamber 106 when the user operates the first trigger 114. In order to effectuate the selection of the chamber from which the apparatus 100 sprays, the switch 124 may be mechanically connected to a valve 126, such as a three-way valve, disposed along a fluid connection, such as a tube or piping, between each of the first chamber 104 and the second chamber 106 and a pump 132, such that the operation of the valve 126 may determine from which of the first chamber 104 and/or the second chamber 106 the pump 132 draws and ultimately expels liquid.

In an alternative embodiment, the switch 124 may be configured with a third position. If the switch 124 is in the third position, the apparatus 100 may simultaneously spray liquids from the first chamber 104 and the second chamber 106 when the user operates the first trigger 114. In another alternative embodiment, the switch 124 may be omitted entirely and the valve 126 may be configured to permanently allow fluid connection between the pump 132 and each of the first chamber 104 and the second chamber 106. In such a configuration, when the user operates the first trigger 114, the pump 132 may simultaneously draw liquids from each of the first chamber 104 and the second chamber 106 and expel the mixed liquids from the first outlet 110.

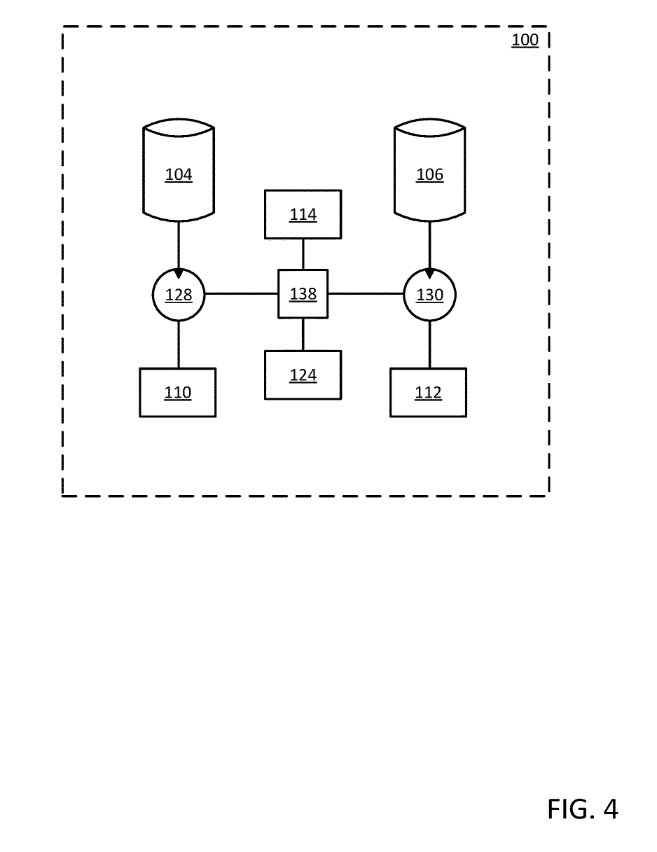

In one exemplary embodiment, the apparatus 100 include a pump corresponding to each chamber and outlet, a trigger, and a switch that controls which of the pumps the trigger operates when the trigger is operated. In FIG. 4, the apparatus 100 may include the first chamber 104 fluidly connected to the first outlet 110, with the first pump 128 disposed along the fluid connection to force the liquid of the first chamber 104 out the first outlet 110. The apparatus 100 may further include the second chamber 106 fluidly connected to the second outlet 112. The second pump 130 may be disposed along the fluid connection between the second chamber 106 and the second outlet 112 to force the liquid of the second chamber 106 out the second outlet 112. The first trigger 114 may be mechanically connected to a mechanical linkage 138. The mechanical linkage 138 may be mechanically connected to each of the switch 124, the first pump 128 and the second pump 130. The mechanical linkage 138 may transmit a mechanical operation of the first trigger 114 to one of the first pump 128 and the second pump 130 according to the position of the switch 124. For example, if the switch 124 is in the first position, the mechanical operation of the first trigger 114 may be transmitted to the first pump 128 and, thus, cause the liquid in the first chamber 104 to be forced out of the apparatus via the first outlet 110. If the switch 124 is in the second position, the mechanical operation of the first trigger 114 may be transmitted to the second pump 130 and, thus, cause the liquid in the second chamber 106 to be forced out of the apparatus via the second outlet 112.

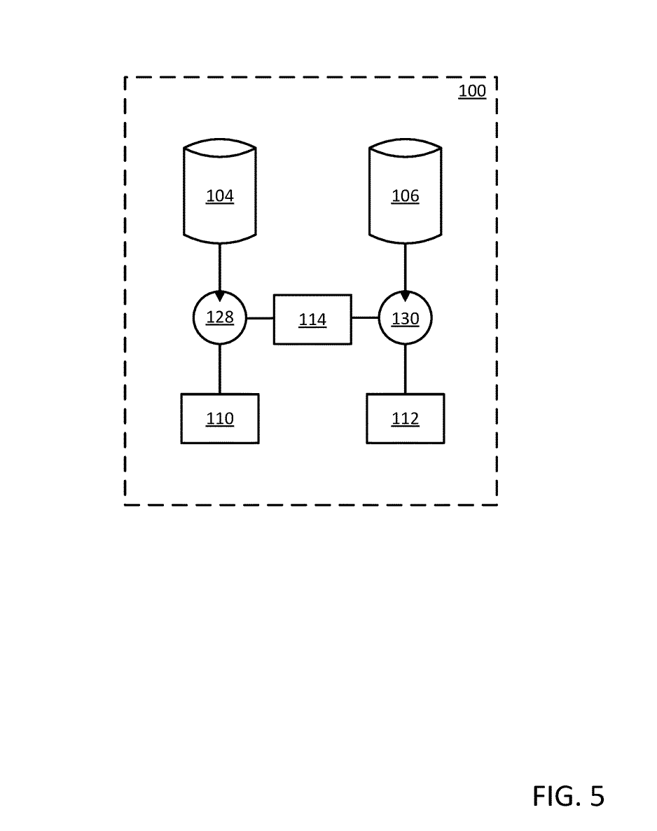

FIG. 5 depicts a schematic illustration of various components of the apparatus 100 in an exemplary configuration in which the liquids in both the first chamber 104 and the second chamber 106 are simultaneously expelled from the apparatus 100. In this exemplary configuration, the first trigger 114 is mechanically connected to the first pump 128 and the second pump 130. When the first trigger 114 is operated, both the first pump 128 and the second pump 130 may force liquid from the first chamber 104 and the second chamber 106, respectively, out of the first outlet 110 and the second outlet 112, respectively. Alternatively, instead of the two liquids spraying from separate outlets, the fluid connections downstream from the first pump 128 and the second pump 130 may be joined into a single fluid connection leading to a single outlet, such as the first outlet 110. In another alternative configuration, the fluid connection between the first chamber 104 and the first pump 128 and the fluid connection between the second chamber 106 and the second pump, as shown in the configuration depicted in FIG. 5, may instead be joined into a single fluid connection that leads to a single pump, such as the first pump 128, and a single outlet, such as the first outlet 110.

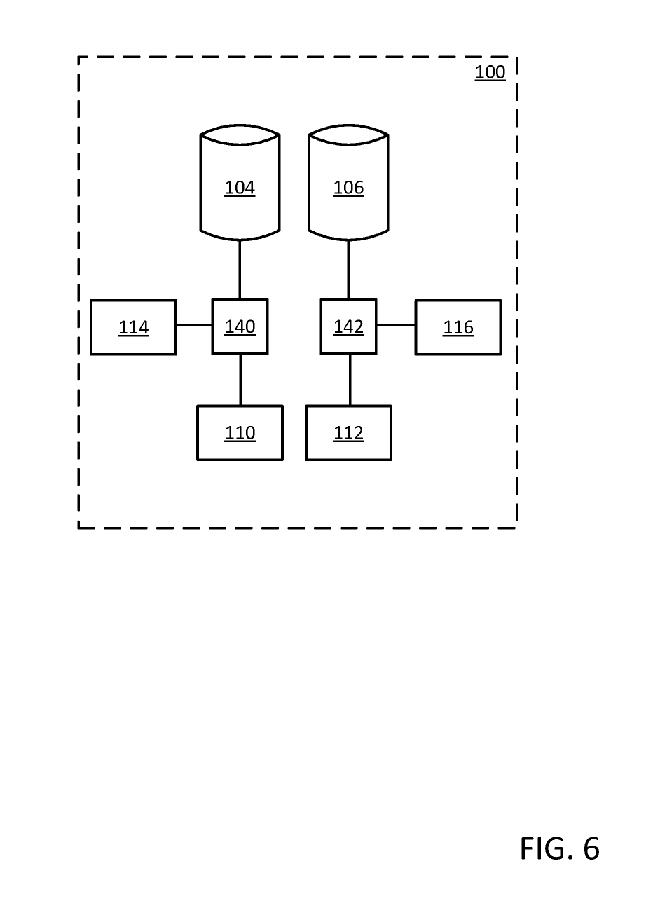

In an exemplary embodiment, one of more of the chambers of the apparatus 100 may be pressurized. FIG. 6 depicts a schematic diagram of an exemplary embodiment in which the first chamber 104 and the second chamber 106 each comprise a pressurized chamber. In such an embodiment, the pressure within the first chamber 104 and the second chamber 106 may force the liquid contained in the respective chamber from the apparatus 100. At least because the pressure within each the first chamber 104 and the second chamber 106 may provide the propulsive means to expel the respective liquid out of the apparatus 100, such an embodiment may omit a pump, such as the first pump 128 and/or the second pump 130, disposed between the first chamber 104 and the first outlet 110 and/or between the second chamber 106 and the second outlet 112. A first valve 140, such as a two-way valve, may be disposed along the fluid connection between the first chamber 104 and the first outlet 110. A second valve 142, such as a two-way valve, may be disposed along the fluid connection between the second chamber 106 and the second outlet 112. When the first valve 140 is open, the pressure within the first chamber 104 may force the first liquid within the first chamber 104 out of the apparatus 100 via the first outlet 110. The second valve 142 may operate similarly with respect to the second chamber 106. The first valve 140 may be mechanically connected to the first trigger 114 and the second valve 142 may be mechanically connected to the second trigger 116. Operation of the first trigger 114 or the second trigger 116 may cause the respective first valve 140 or second valve 142 to be opened and, thus, effectuate the liquid in the respective first chamber 104 or second chamber 106 to be expelled from the apparatus 100. It will be appreciated that the use of a pressurized chamber to propel a fluid instead of a pump is not limited to the examples described in relation to FIG. 6, but may also be similarly incorporated into other examples described herein.

One or more components (e.g., the first pump 128, the second pump 130, the first outlet 110, the second outlet 112, and/or the fluid connections connecting the same) of the apparatus 100 may be configured to release a first amount of the first liquid (e.g., the liquid in the first chamber 104) and a second amount of the second liquid (e.g., the liquid in the second chamber 106) such that the ratio of the first amount to the second amount is a predetermined ratio. For example, the first pump 128 may be configured to force a first amount of the first liquid from the apparatus while the second pump 130 may be configured to force a second amount of the second liquid from the apparatus. As another example, the first outlet 110 may be configured (e.g., the opening of the first outlet 110 is particularly sized) to spray the first liquid in a first amount or first rate and the second outlet 112 may be configured to spray the second liquid in a second amount or second rate. Similarly, the fluid connection, or a portion thereof, connecting the first chamber 104 and the first outlet 110 may be configured to allow a first amount, or at a first rate, of the first liquid to flow within said fluid connection. The fluid connection, or a portion thereof, connecting the second chamber 106 and the second outlet 112 may be configured to allow a second amount, or at a second rate, of the second liquid to flow within said fluid connection. As an illustration, using the example depicted in FIG. 5, the first pump 128 may be configured to pump a first amount of the first liquid from the first chamber 104 and the second pump 130 may be configured to pump a second amount of the second liquid from the second chamber 106, wherein the first amount of the first liquid is twice the second amount of the second liquid. In this manner, when the first trigger 114 is operated, the apparatus 100 will simultaneously spray the first liquid and the second liquid in a 2:1 ratio.

As mentioned, the chambers of the apparatus 100 may include different substances (e.g., liquids). For example, the first chamber 104 may contain a first liquid and the second chamber 106 may contain a second liquid, wherein the first liquid and the second liquid are different from one another. One of the first liquid or the second liquid may be a liquid that causes a chemical reaction when mixed or brought into contact with the other liquid. The chemical reaction may facilitate or cause an animal waste to at least partially dissolve. In various embodiments of the present disclosure, the first liquid may include a first dissolution aid and the second liquid may include a second dissolution aid. Moreover, the first liquid and the second liquid may be configured so that the respective dissolution aids are distinct liquids that generate an exothermic reaction upon mixing to dissolve the undesired animal waste. In an aspect, the first liquid and the second liquid may be configured so that an endothermic reaction results upon mixing the first liquid and the second liquid.

As used herein, dissolving the animal waste may refer to a transformation of at least part of the animal waste in to a plurality of sub-particles. As a further example, dissolving the animal waste may also refer to the decomposition of at least part the animal waste upon contact with one or more of the liquids contained in the apparatus, such as the water and dissolution aid. In one example, the applications of distinct dissolution aids may dissolve or decompose the animal waste.

Generally, the first dissolution aid may include a fluid configured to dissolve at least a portion of the animal waste when contacted with the animal waste and a separate, distinct second dissolution aid. In certain examples, the second dissolution aid may be sprayed onto the animal waste which has been sprayed with the first dissolution aid from the apparatus 100.

The first liquid may be a first dissolution aid of water. As described herein, water can be used in the methods exemplified in various embodiments of the present disclosure. As an example, the water may be distilled or deionized. In further examples, the water may be an ultra-pure water meeting the specifications required to comply with various authorities, including but not limited to ASTM D5127 and ISO 3696. In yet further examples, the water may be tap water, such as household tap water. The tap water may be filtered or unfiltered.

Where the first liquid comprises water as a first dissolution aid, the second liquid may include acid liquid as a second dissolution aid. Interaction of acid liquid with the water may generate a sufficiently exothermic reaction to dissolve at least a portion of the animal waste. Appropriate acid liquids may include but are not limited to nitric acid, perchloric acid, and sulfuric acids, or a mixture thereof. As such, in preferred embodiments, the acid liquid may include oxygen or nitrogen as an oxidizing component.

In some examples, the acid liquid may be a neat liquid. In further examples, the acid liquid may be in solution having a particular concentration. To dissolve at least a portion of the animal waste, including organic matter therein, the acid liquid may have a pH of up to about 6 on the pH scale when measured according to standard test methods, including but not limited to ASTM E70. As used herein, the pH refers to the standard measure of the hydrogen ion concentration of a specimen and is represented using a logarithmic scale. It is to be appreciated that the type of acid liquid selected may determine the necessary concentration to achieve the desired value for the pH.

As an example, the first dissolution aid may include an oxidizing agent. As the first dissolution aid, the oxidizing agent may be sprayed onto the animal waste. Contact of the oxidizing agent with the animal waste and a second dissolution aid from the apparatus 100 may generate an exothermic reaction. The energy expelled through the exothermic reaction thereof may evaporate a portion of water and oxidize a portion of the animal waste to ash. Here, the animal waste, containing organic matter, may be dissolved or decomposed by the oxidizing agent. As an example, the oxidizing agent may decompose, or reduce, carbonaceous organic matter (organic matter having carbon) of animal waste to carbon dioxide and water. In further examples, the oxidizing agent may also reduce nitrogenous organic matter (organic matter having nitrogen) of animal waste. Via a redox reaction wherein electrons are transferred, the oxidizing agent accepts electrons from the organic matter thereby reducing the organic matter to a decomposed state.

As one skilled in the art might appreciate, oxidizing agents may generally include chromates, hypochlorites, hypervalent iodine compounds, osmium compounds, permanganates, perchlorates, and peroxides, as well as peroxy acids and the salts thereof, among others. As such, exemplary oxidizing agents may include, but are not limited to permanganates such as potassium permanganate or sodium permanganate, potassium persulfate, potassium dichromate, ammonium dichromate, sodium perborate, or sodium percarbonate, sodium percarbonate, potassium percarbonate, sodium perborate, potassium perborate, sodium peroxide, potassium peroxide, calcium peroxide, magnesium peroxide, lithium peroxide, barium peroxide, and cesium peroxide. Further examples may include halogenated oxidizing agents such as potassium bromate or potassium iodate.

In further examples, a first dissolution aid may include a microbial agent. The microbial agent may dissolve or decompose the animal waste by bacterial metabolism. That is the dissolution aid may include a microbial agent configured to digest the organic material subsisting within the animal waste.

In some examples where the first dissolution aid is an oxidizing agent or anti-microbial agent, the first dissolution aid may be accompanied by the use of an acid liquid as a second dissolution aid. The acid liquid may include organic or inorganic acids. Appropriate acid liquids may include but are not limited to nitric acid, perchloric acid, and sulfuric acids. As a further example, the acid liquid may facilitate decomposition where the first dissolution aid is an oxidizing agent. The acid liquid may act to further decompose the organic matter or enhance the oxidizing effect of the oxidizing agent. As such, in preferred embodiments, the acid liquid may include oxygen or nitrogen as an oxidizing component. In an example, the first liquid may comprise hydrogen peroxide solution and the second liquid may comprise sulfuric acid. More specifically, the first liquid may comprise a hydrogen peroxide solution having a concentration of up to about 40%, or from about 15% to about 40%. The second liquid may comprise a concentrated sulfuric acid solution wherein the concentration of the sulfuric acid solution is from about 95% to about 99%.

As one example of a combination of the first liquid and the second liquid, the first liquid may include a peroxide solution, such as hydrogen peroxide solution, and the second liquid may include sulfuric acid. The sulfuric acid may first be sprayed by the apparatus 100 onto the animal waste and then the peroxide solution may sprayed onto the animal waste, thereby mixing the sulfuric acid with the peroxide solution upon and within the animal waste. The exothermic reaction resulting from the mixture may dissolve at least a portion of the animal waste. The apparatus 100 may be configured to spray the peroxide solution and the sulfuric acid according to a predetermined ratio, as described above, that provides a sufficient exothermic reaction to dissolve the animal waste but not put the user or a bystander in danger of harm. As an example, a ratio of sulfuric acid to peroxide solution may be 3:1, with the peroxide solution at 30% concentration. In further examples, the ratio of sulfuric acid to peroxide solution may be from about 3:1 to about 7:1.

It will be appreciated that the first liquid and the second liquid as described herein may be interchanged. In some aspects, the order in which the first liquid and the second liquid are sprayed onto the animal waste may be interchanged. In other aspects, a certain order in which the first liquid and the second liquid are sprayed may be preferable. For example, when the first liquid is water and the second liquid is an acid liquid, it may be preferable for the first liquid to be first sprayed on the animal waste and then followed with the second liquid. As another example, when the first liquid comprises an oxidizing agent and the second liquid comprises an acid liquid, it may be preferable for the second liquid to be sprayed on the animal waste and then the first liquid to be sprayed.

As noted herein, the apparatus 100 may contain a plurality of chambers such as the first chamber 104 and the second chamber 106 containing a first liquid and a second liquid, respectively. Accordingly, the apparatus may include one or more additional chambers disposed on or within the apparatus 100 in a similar manner as the first chamber 104 or the second chamber 106. In some embodiments, the apparatus 100 may contain one or more additional liquids having dissolution aids. The liquids may be disposed within one or more additional chambers.

In some embodiments, the apparatus 100 may contain an acid liquid, such as in a chamber disposed on or within the apparatus 100 in a similar manner as the first chamber 104 or the second chamber 106. The acid liquid may be sprayed from the apparatus 100 onto the animal waste before or after the first liquid and the second liquid are applied to the animal waste. The acid liquid may serve as a further dissolution aid to further dissolve at least a portion of the animal waste. As described herein, the acid liquid may be organic or inorganic. For example, the acid liquid may be nitric acid, hydrofluoric acid, or sulfuric acid.

In yet other embodiments, the apparatus 100 may contain a bleach liquid as a further dissolution aid, such as in a chamber disposed on or within the apparatus 100 in a similar manner as the first chamber 104 or the second chamber 106. The bleach liquid may be sprayed from the apparatus 100 onto the animal waste before or after the first liquid and the second liquid are spayed onto the animal waste. The bleach liquid may serve as an anti-microbial agent and kill at least a portion of the bacteria residing in the animal waste. The bleach liquid may include, for example, sodium hypochlorite, calcium hypochlorite, hydrogen peroxide, sodium percarbonate, sodium perborate, sodium dithionite, sodium borohydride, or a combination thereof. It is to be appreciated that the concentration of peroxide or chloride in the bleach may vary. In an example, the amount of chloride in the bleach liquid may be greater than about 100 ppm. In further examples, the amount of chloride in the bleach liquid may be from greater than about 200 ppm to about 25,000 ppm or from greater than about 200 ppm to about 50,000 ppm. In one example, the bleach liquid may include a hydrogen peroxide solution having a concentration in an amount from about 1% to about 50%.

In one embodiment, one of the substances, such as the first or second liquid, expelled by the apparatus 100 may include a surfactant. For example, a surfactant may include a detergent, such as alkylbenzenesulfonate.

In one embodiment, one or more of the substances, such as the first liquid or the second liquid, may contain a coloring agent. When the substance containing the coloring agent is sprayed on the animal waste, the coloring agent may serve to assist the user in determining which parts of the animal waste are treated. Further, when animal waste is treated using the apparatus 100, the coloring agent may serve to provide notice to the user or the public at large that the animal waste has been treated with the apparatus 100.

As an example, the apparatus 100 may be used, when filled with at least the first liquid and the second liquid, to at least partially dissolve animal waste, such as dog feces. The user may direct the apparatus 100 towards the animal waste that the user wishes to dissolve and cause the apparatus 100 to spray the first liquid onto the animal waste. For example, the user may squeeze the first trigger 114 to cause the first liquid to spray from the first outlet 110 of the apparatus 100 onto the animal waste. The user may then spray the second liquid onto the animal waste. For example, the user may squeeze the second trigger 116 to cause the second liquid to spray from the second outlet 112 of the apparatus 100 onto the animal waste. It will be appreciated that the order in which the liquids may be sprayed onto the animal waste may be reversed or otherwise varied. In some embodiments, as described herein, the first liquid and the second liquid may be simultaneously sprayed from the apparatus 100 onto the animal waste. When the first liquid and the second liquid are sprayed on the animal waste, or shortly thereafter, a chemical reaction may occur that at least partially dissolves the animal waste. The user may additionally spray an acid liquid from the apparatus 100 onto the animal waste to further facilitate the animal waste dissolving. Further, the user may spray a bleach liquid from the apparatus 100 onto the animal waste to disinfect the dissolving animal waste.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

While the disclosure has been described in connection with the various embodiments of the various figures, it is to be understood that other similar embodiments can be used or modifications and additions can be made to the described embodiments. Therefore, the apparatus for at least partially dissolving animal waste as described herein should not be limited to any single embodiment, but rather should be construed in breadth and scope in accordance with the appended claims.

1. An apparatus for dissolving animal waste, the apparatus comprising:
a housing;
a first chamber connected to the housing, the first chamber containing a first substance;
a second chamber connected to the housing, the second chamber containing a second substance, wherein the first substance and the second substance react, when at least partially mixed with one another, to at least partially dissolve animal waste;
a first trigger connected to the housing, the first trigger configured, upon operation of the first trigger, to cause the first substance to be expelled from the apparatus; and
a second trigger connected to the housing, the second trigger configured, upon operation of the second trigger, to cause the second substance to be expelled from the apparatus.

2. The apparatus of claim 1, further comprising:
a first pump in fluid connection with the first chamber, the first pump in mechanical connection with the first trigger; and
a second pump in fluid connection with the second chamber, the second pump in mechanical connection with the second trigger.

3. The apparatus of claim 1, wherein the first chamber is pressurized.

4. The apparatus of claim 3, further comprising:
a valve in fluid connection with the first chamber, the valve in mechanical connection with the first trigger such that operation of the first trigger causes the valve to open.

5. The apparatus of claim 1, further comprising:
a safety mechanism configured to prevent the expulsion of at least one of the first substance and the second substance from the apparatus unless the apparatus is oriented substantially downward.

6. The apparatus of claim 1, wherein the first substance comprises water and the second substance comprises an acid liquid.

7. The apparatus of claim 1, wherein the first substance comprises an oxidizing agent and the second substance comprises an acid liquid.

8. The apparatus of claim 1, wherein at least one of the first substance and the second substance comprises a coloring agent.

9. The apparatus of claim 1, further comprising:
a third chamber connected to the housing, the third chamber containing a third substance; and
a third trigger connected to the housing, the third trigger configured, upon operation of the third trigger, to cause the third substance to be expelled from the apparatus.

10. The apparatus of claim 9, wherein the third substance comprises a detergent.

11. An apparatus for at least partially dissolving animal waste, the apparatus comprising:
a housing having an outlet;
a first chamber connected to the housing, the first chamber containing a first substance;
a second chamber connected to the housing, the second chamber containing a second substance, wherein the first substance and the second substance react, when at least partially mixed with one another, to at least partially dissolve animal waste; and
a trigger connected to the housing, the trigger configured, upon operation of the trigger, to cause at least one of the first substance or the second substance to be expelled from the apparatus via the outlet.

12. The apparatus of claim 11, wherein the trigger is further configured, upon operation of the trigger, to cause the first substance and the second substance to be expelled from the apparatus via the outlet.

13. The apparatus of claim 11, further comprising:
a switch connected to the housing, the switch having a first position and a second position wherein, upon operation of the trigger, the first substance is expelled from the apparatus when the switch is in the first position and the second substance is expelled from the apparatus when the switch is in the second position.

14. The apparatus of claim 13, further comprising:
a valve in mechanical connection with the switch, wherein:
when the switch is in the first position, the valve enables a flow of the first substance from the first chamber and disables a flow of the second substance from the second chamber; and
when the switch is in the second position, the valve enables the flow of the second substance from the second chamber and disables the flow of the first substance from the first chamber.

15. The apparatus of claim 11, further comprising:
a pump in fluid connection with the first chamber and the second chamber, the pump in mechanical connection with the trigger.

16. The apparatus of claim 11, further comprising:
a safety mechanism configured to prevent the expulsion of at least one of the first substance and the second substance from the apparatus unless the apparatus is oriented substantially downward.

17. The apparatus of claim 11, wherein the first chamber is pressurized.

18. The apparatus of claim 17, further comprising a valve in fluid connection with the first chamber, the valve in mechanical connection with the trigger such that an operation of the trigger causes the valve to open.

19. The apparatus of claim 11, wherein the first substance comprises water and the second substance comprises an acid liquid.

20. The apparatus of claim 11, wherein the first liquid comprises an oxidizing agent and the second liquid comprises an acid liquid.

21. The apparatus of claim 11, further comprising an attachment point for a leash.

22. The apparatus of claim 11, further comprising:
a third chamber connected to the housing, the third chamber configured to contain a third substance, wherein the switch has a third position wherein, upon operation of the trigger, the third substance is expelled from the apparatus when the switch is in the third position.

23. The apparatus of claim 22, wherein the third substance comprises a bleach liquid.

24. A method for at least partially dissolving animal waste, the method comprising:
operating a trigger mechanism of an apparatus to cause a first substance to be expelled from the apparatus onto the animal waste, wherein the first substance is contained in a first chamber of the apparatus; and
operating the trigger mechanism of the apparatus to cause a second substance to be expelled from the apparatus onto the animal waste, wherein the second substance is contained in a second chamber of the apparatus.

25. The method of claim 24 wherein the first substance comprises water and the second substance comprises an acid liquid.

26. The method of claim 24 wherein the first substance comprises an oxidizing agent and the second substance comprises an acid liquid.
